(19) United States
(12) Patent Application Publication
(10) Pub. No.: US 2004/0187099 A1
(43) Pub. Date: Sep. 23, 2004

(54) System and method for processing price plans on a device based rating engine

(75) Inventors: Scott A. Irwin, Winter Springs, FL (US); Robert D. Birch, Orlando, FL (US); Joseph P. Lupo, Apopka, FL (US); Bichvan Thi Vu, Orlando, FL (US); Dell Shen, Maitland, FL (US); Stephen D. Weagraff, Orlando, FL (US)

Correspondence Address: FROST BROWN TODD, LLC, 2200 PNC CENTER, 201 E. FIFTH STREET, CINCINNATI, OH, 45202, US

(73) Assignee: Convergys Information Management Group, Inc.

(21) Appl. No.: 10/739,259

(22) Filed: Dec. 18, 2003

Related U.S. Application Data
(63) Continuation-in-part of application No. 10/392,496, filed on Mar. 20, 2003.

(51) Int. Cl. G06F 9/44

(52) U.S. Cl. 717/136; 717/114; 717/108

(57) ABSTRACT

There is disclosed a simplified rating language for crafting price plans for ratable events which may be interpreted by either a source level interpreter resident upon a device also comprising a device based rating engine or via a virtual machine designed for said rating language.

This is a non-provisional, continuation-in-part patent application which claims priority from U.S. patent application Ser. No. 10/392,496, Irwin, et al., filed Mar. 20, 2003.

### FIELD OF THE INVENTION

This invention is in the field of computerized billing systems and particularly the utilization of a customized rating language to facilitate the processing of price plans on device-based rating engines.

### BACKGROUND OF THE INVENTION

Single purpose computerized end devices, i.e., cell phones, pagers, personal digital assistants, etc., have become commonplace. These single purpose devices have not, in the past, included application hosting facilities given the network and processors that were available. Any intelligence had to be found in the “hosts” that they were attached to.

Four key trends are shaping the computerized billing industry: increased processing power on user devices, longer lasting batteries for user devices, standardization of the development and operating environment on the user device (standard operating systems), and finally the demand and growth of applications executing on the user device. End devices are rapidly moving from simple, proprietary, single purpose devices to full-fledged mobile application deployment platforms.

As technology advances, so must the billing and customer care applications which support service offerings/content access on the end-device. Customer care and billing applications (including pre-paid applications) have generally followed a network-centric or server-centric processing model (please see, U.S. Pat. No. 6,198,915 by Russo, which issued on Mar. 6, 2001). Network-centric models process and store information centrally in the network. The device or access point generates/facilitates the data or events. Customer data is housed on centralized databases. Rating and billing for events involves some sort of network activity or usage.

Even where some processing functionality takes place on an end device (please see, U.S. Pat. No. 5,577,100, by McGregor, which issued on Nov. 19, 1996, and U.S. Pat. No. 6,198,915, by Russo, which issued on Mar. 6, 2001), such applications are marked by a server-controlled relationship and are very limited in the scope of functionality offered on the end device.

The rating systems used today typically require static logic in conjunction with large centralized databases that can be used to decorate the static logic with limited dynamic behavior.

### SUMMARY OF THE INVENTION

Various embodiments (including systems and methods) for processing price plans on a device-based rating engine are disclosed. These embodiments may employ one or more of the following features disclosed herein either singly or in combination. These embodiments may utilize current and emerging technologies as well as technologies yet to come. The device-based rating engine comprises a computerized application which facilities the metering, rating, billing and managing of account balances on an end computing device whether the device may be connected to a network or not connected to a network. The device-based rating engine may be incorporated into virtually any end device that is capable of hosting (or may be adapted to host) the application including personal computers, phones, handheld devices, PDAs, cameras, music players, game consoles, and cars as well as more generic consumer devices such as parking meters, kiosks, washing machines, vending machines and more.

This application presents a new alternative in developing price plans for device-based rating engines hosted on a device by utilizing a rating programming language to describe a price plan, which may be then executed in either an Interpretive or Virtual Machine model. This approach may execute a price plan without accessing a centralized database. Rather, all of the necessary logic may be encapsulated within the language. In an enterprise solution, a database may be used to catalog the price plan documents, but the database is not necessary for the runtime execution of the compiled price plan.

The rating language allows the sequence of the most efficient path to the price to be coded within the language while also providing for flexibility to modularity.

In one embodiment, there may be a method by which a device may be configured to process a price plan including defining a price plan in a programming language designed for configuring rating algorithms and loading said price plan onto a device. The device may be configured with a device-based rating engine and a source level interpreter for said programming language. The programing language may be developed from scratch or as a subset or derivative of an existing programming language. In a preferred embodiment, the programming language may be a derivative of XML. An embodiment may be further configured by developing the source level interpreter to select an applicable price plan; parse said price plan to create an execution tree; receive an event; and execute said price plan as represented by said execution tree. The price plan may be constructed to execute in a very efficient manner so that a minimum of processing resources are expended in the execution of the price plan on the device. Specifically, as the price plan may be constructed in a binary tree, the first branches in the tree may be coded to represent those types of usages most commonly used. This way, it is not necessary for the entire price plan to be parsed to get to the most popular means of usage. The price plan may be constructed generically by surveying the most popular usages for a particular demographic, a particular device, or customizing the plan to an individual customer based upon their chosen preferences.

In another embodiment, a device may be configured to execute a price plan comprising the steps of defining a price plan in a proramming language designed for configuring rating algorithms; parsing said price plan on a system remote from said device to produce an execution tree; and loading said execution tree on said device wherein said device is further configured with a device based rating engine. The device based rating engine may be further configured to receive an event; select an execution tree applicable to said event; and execute said price plan as represented by said execution tree. The price plan may be defined in a programming language designed for configuring rating algorithms. The price plan may be loaded on a remote device wherein said device is further configured with a price plan parser; it may be parsed on said device to produce an execution tree; and the execution tree may be loaded on said device wherein said device is further configured with a device based rating engine. The device based rating engine may be further configured to receive an event; select an execution tree applicable to said event; and execute said price plan as represented by said execution tree. The price plan may be constructed generically by surveying the most popular usages for a particular demographic, a particular device, or customizing the plan to an individual customer based upon their chosen preferences.

In another embodiment, a device may be configured to execute a price plan comprising the steps of defining a price plan in a programming language designed for configuring rating algorithms; compiling said price plan on a system remote from said device into a byte code representation of said price plan; and loading said byte code on said device. The device may be further configured with a device based rating engine and a virtual engine for executing said byte code. The device based rating engine may be further configured to receive an event; select said byte code applicable to said event; and execute said price plan as represented by said byte code. The price plan may be constructed generically by surveying the most popular usages for a particular demographic, a particular device, or customizing the plan to an individual customer based upon their chosen preferences.

In another embodiment, a device-based rating engine may be configured with a source level interpreter which has been configured to select a price plan stored on said device based rating engine, wherein said price plan is defined in a rating-specific programming language, and further wherein said source level interpreter is configured to parse said price plan into an execution tree which it may implement when the source level interpreter receives an appropriate event.

In another embodiment, a device based rating engine may be configured with a virtual machine for executing a set of byte code compiled from a price plan defined in a rating-specific programming language wherein said device based rating engine may receive an event, select the set of byte code corresponding to said event, and execute said byte code in said virtual machine to calculate a charge associated with said event.

Many more embodiments are possible within the teachings of this application.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers.

FIG. 1 depicts the creation of a Price Plan and interprets engine.

FIG. 1A represents an example of XmURL code for evaluating an expression.

FIG. 1B represents an example of XmURL code for grouping evaluation expressions.

FIG. 1C represents an example of XmURL code for evaluating a range expression.

FIG. 1D represents an example of XmURL code for evaluating a complex expression.

FIG. 1E represents an example of XmURL code for evaluation of a conditional expression.

FIG. 1F represents an example of XmURL code for setting values.

FIG. 1G represents a possible price plan script in intermediate pseudocode.

FIG. 2 illustrates an embodiment of the entities in a binary tree.

FIG. 3 illustrates an embodiment of the entities involved in the building of a Price Plan.

FIG. 4 illustrates an embodiment in which the construction of the Price Plan is distributed.

FIG. 5 illustrates an embodiment of a virtual machine.

FIG. 6 illustrates an embodiment of the compilation of byte code for a virtual machine.

FIG. 7 illustrates one possible architecture for a virtual machine.

FIG. 8 illustrates one possible layout of virtual machine code.

FIG. 9 illustrates one possible embodiment of a virtual code segment.

FIG. 10 displays a UML representation of the workflow through a virtual engine.

FIG. 10A represents an example of a data structure for a DBRVM.

FIG. 10B represents an example of a dispatch table.

FIG. 10C represents an example of a dispatching routine.

FIG. 10D represents an example of stack based load instructions.

FIG. 10E represents a sample assembler program.

FIG. 10F represents an XmURL code fragment.

FIG. 10E represents subroutine support in XmURL.

FIG. 11 depicts an embodiment of an Assembler.

FIG. 12 displays a UML Diagram that illustrates the major sequences undertaken by an assembler program to transform assembly source into VMSource (Byte code).

### DETAILED DESCRIPTION OF THE EMBODIMENTS

This application discusses the utilization of a device-based rating engine, as described in U.S. patent application Ser. No. 10/392,496 (publication number US2003-0187794 and incorporated herein by reference), which employs a rating language to define price plans for execution on the device in a variety of forms. Other device-based rating engines may be employed; the engine described in the aforementioned application is merely offered for explanatory purposes. The terms engine/application/program as used herein will refer to any embodiment of computer-executable instructions on a computer readable medium including but not limited to software, hardware, firmware, modules, programs, routines, etc.

The programs described herein are presented according to principles of object-oriented design, the terms and concepts inherent to this model will be easily understood by those of skill in the art; however, it should be understood that other programming methodologies would work as well.

XmURL

Price plans may be defined and verified using an XML syntax called XmURL (eXtensible Meta Usage Rating Language). XmURL is a special purpose language created specifically for rating. Programs screated using XmURL may be externalized and transmitted down to the DBR for execution even on memory constrained devices.

The XmURL document that represents a price plan can be verified using an XML Schema. A Schema defines the syntax and relationships between elements of the language. In addition, there are many XML tools that provide an XmURL language editor having been provided the XmURL Schema. The XmURL document can be easily parsed into its elements using industry standard frameworks. Once parsed, the representation can been either executed in an interpreter engine, or transformed into a compact byte code presentation that can be executed within a XmURL virtual machine.

XML Based Price Plan Definition

XmURL represents a minimalist language that supports a set of programming constructs for executing a price plan that determines a rate of a unit charge applied to an agnostic event in time. The execution of the XmURL may occur within distributed, constrained consumer devices. Constrained devices may have limitations including, but not limited to, memory and processing power. Large scale rating systems may also benefit from the XmURL approach to rating.

The language supports a set of primitive types, which may include integer, string, double, timestamp, date, time, day of the week, day of the month, and day of the year.

XmURL rating algorithms may utilize data from five sources:

a) A hard-coded Constant Value declared within the XmURL price plan;

b) An Event Value that may be provided as part of the ratable event being passed to the engine;

c) An Accumulation Value that represents persistent state in support of the rate plan;

d) A Derived Value that represents local data variables. These variables may have global scope within the context of a single rating occurrence; and

e) A Parameterized Value obtained from rating engine's execution environment which provides the ability to template price plans for reuse by configuration. For example, a price plan might be scripted to provide free usage on the consumer's birthday. A Parameterized Value may be used to represent the date in the XmURL document to prevent the customization of an XmURL document for each consumer. When the script executes, it obtains the Parameterized Value from the environment to perform the evaluation.

The language provides constructs for complex expressions using AND, OR and NOT. The expressions may be built using Evaluation Tests. These tests can be comparisons between two data sources for equivalency (e.g., =, !=, <, >, <=, >=), comparing a field with a range (in or out) of other values, as well comparing a field with a set of values (in or out). By nesting Evaluation Tests within AND/OR tags, complex expressions may be built. Tags can also have the optional NOT qualification to inverse the result of the expression.

Comparison evaluations rely on arguments that define the left and right values.

Range evaluations rely on a single field source compared with a high and low field source. The Set evaluations rely on a single source field and a list of other fields to comprise the set. These values can be obtained from any of the five data sources.

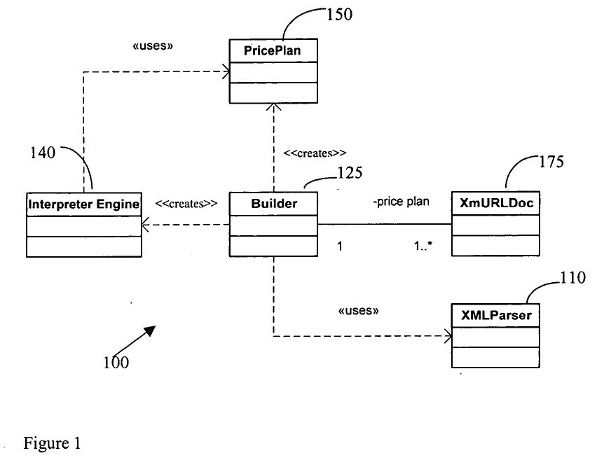

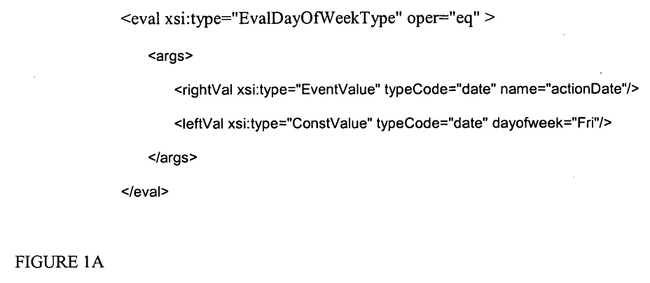

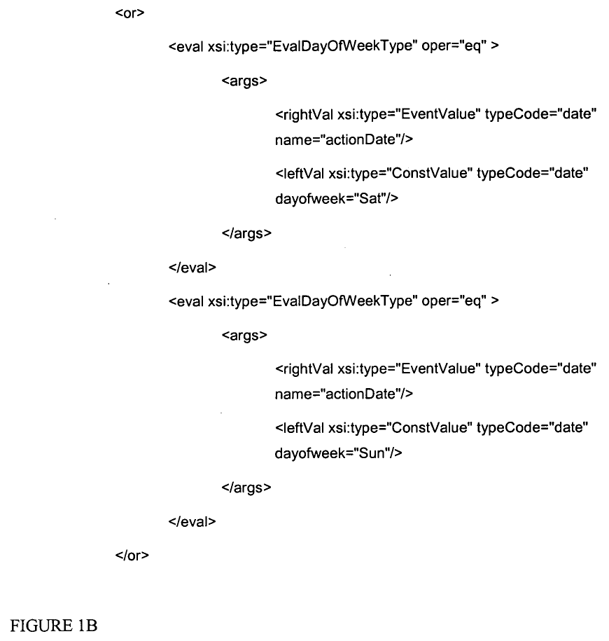

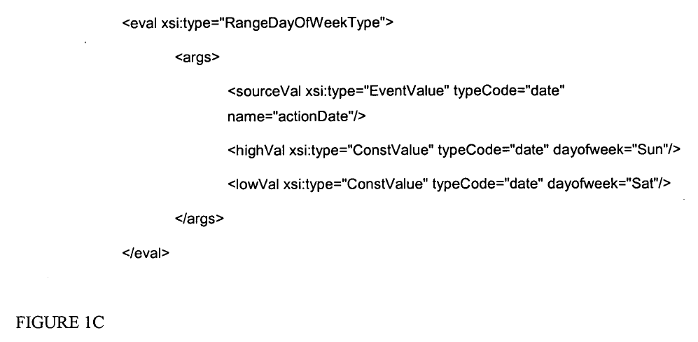

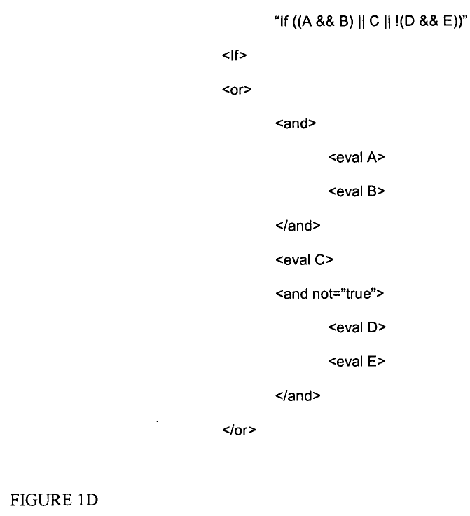

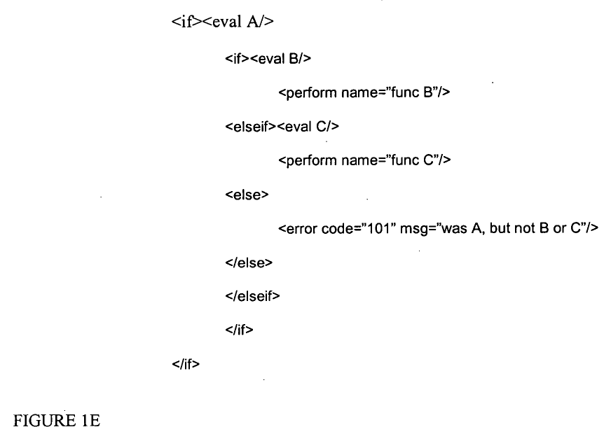

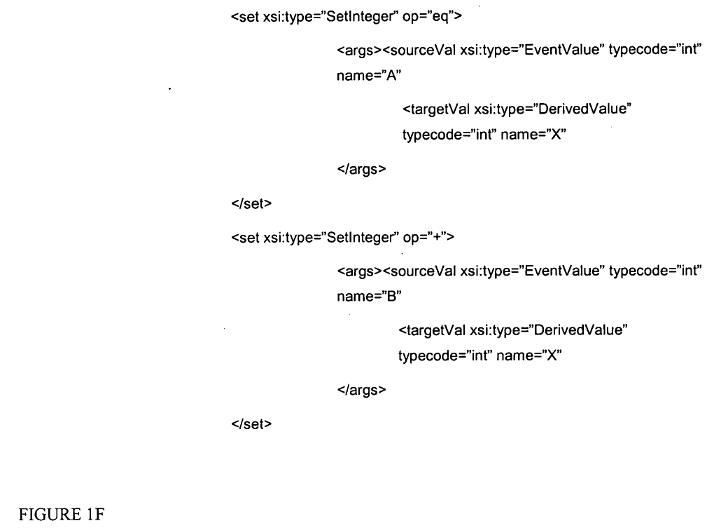

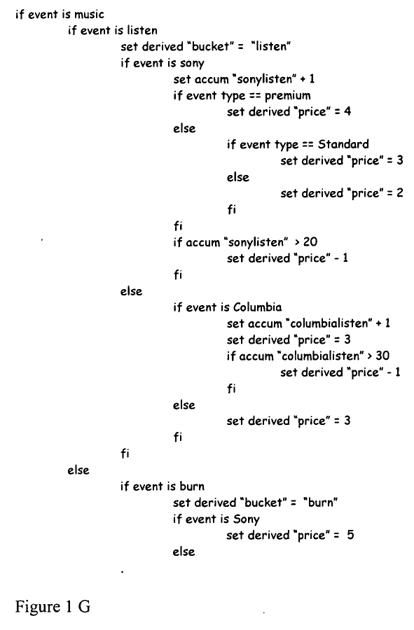

Referring to FIG. 1A, an evaluation tests an Event field defined as “actionDate” to determine if the date is a Friday.

Referring to FIG. 1B, evaluations can also be grouped into expressions as in the following example checking for a weekend date.

Referring to FIG. 1C, the example could also be declared using a Set or Range test.

Referring to FIG. 1D, the following abbreviated text illustrates a complex set of expressions for the following test where A, B, C, D and E are some type of evaluation, range or set test.

The engine may short circuit any expression based on the results of the intermediate tests and the expression relationship (i.e., and/or).

The XmURL language can effectively throw an Error from anywhere within the price plan. Code may be minimized by not including a catch for the throw. If an Error occurs, the price plan execution completes and the Event may be marked with a provided error number and optional error message.

The evaluation expressions are expressed as “if/elseif/else” blocks to drive the logic of the price plan. Referring to FIG. 1E, these logic blocks can be nested to any level as in the following abbreviated example.

Another language element may be the “Set” command, which may assign or modify values. The “Set” command may operate on all of the supported data types. However, not all operation types may be supported on each data type. For example, integers and doubles may support multiplication and division while strings may not. “Set” may perform a single action.

Referring to FIG. 1F, the event field “A” is first assigned to a derived field named “X”. If the “X” field doesn't exist as a derived field, it may be created. If it exists, its value may be replaced by the assignment. The second “Set” command performs an add operation using the event field “B” as the source value and adding it to the target field of the “X” derived value.

To increase the modularity of the XmURL, subroutines may be declared at the beginning of the XmURL document. These subroutines can be called from within the price plan may be executed inline with the rest of the XMURL.

XmURL supports an Import statement that provides for the modularity of the price plan documents. Import statements may be specified at any point in an XmURL document. The Import statement may cause the inclusion, at that point, of another XmURL document. The engine may process the included XmURL document as if it were found in place. The contents of the included document are preferably syntactically correct given the placement of the Import statement. Otherwise, an error may result from the processing of the XmURL document.

XmURL Document Construction

The creation of a price plan might start by defining the requirements of the plan to be offered. The following is an example of one such multimedia price plan that might be offered to DBR customers.

Price Plan X

Account gets 500 listen and 75 burn music tokens per month.

Account gets 100 game tokens per month.

Sony Music

Sony offers a discount on listens of Sony music after 20 per month of −1.

Sony rates are 4 —for Premium, 3 —for Regular, 2 —for Oldies.

Sony burns are 5.

Columbia House Music

Columbia offers a discount on listens after 30 per month of −1.

Columbia rates are 3 for listen (all).

Columbia burn rate.

5 for new (<6 months) or <5 burns.

4 for somewhat new <=12 months or <5 bums.

3 for older songs and >=5 burns.

Other Music

All other listens are 3 tokens.

All other bums are 4 tokens.

Games

EA Sports games are stepped at price of 5 (1-10), 4 (11-20), 3 (>20).

All other games are 3 tokens <20 games, 2 tokens=>20 games per month.

Using these requirements, the rules of the plan are then converted into a pseudocode representation based on the most efficient execution path to a price. The most popular usage pattern might be listening to music files. Therefore, the price plan evaluates if the usage is music and listen first. The plan may be constructed based on demographics or personal preference of the consumer. Thus, efficiency may be built into the Price Plan. Referring to FIG. 1G, for example, a possible depiction of Price Plan X in pseudocode is shown.

From this pseudocode, the actual XmURL document can be encoded. The XmURL logic evaluates the event and any necessary accumulation buckets to derive the price. At the end of the evaluation process, the XmURL logic should have set a “price” and “bucket” value in the derived values source. The rating engine will attempt to obtain these named values to continue billing process.

DBR Services

Implementations may use a device based rating engine (DBR) to:

a) select the appropriate XmURL document or byte code that represents the price plan to be executed;

b) provide the environment to obtain the parameterized values declared within the price plan;

c) provide a Context, through which the rating engine will access the Event fields, Derived fields and Accumulation fields;

d) persist the Accumulation field values as altered in the Context.

Implementations

There are several implementation models that could be applied to the system that executes XmURL. The first model may be to build a source level XmURL interpreter and deploy it on the device. This interpreter would parse the rating document and create an execution tree. The resulting execution tree would then be traversed at runtime to execute the plan.

A second model may be to deploy an engine on the server, which may function as a pre-parser for an engine on the device. The server engine may parse the XmURL document to build a binary tree. The tree may be then exported from the engine in a UTF-8 or other known format. This export would preferably be more compact than the XmURL. In addition, the device engine that imports the tree would be simplified by removing a large portion of error checks necessary for initially building the tree from the XmURL. This would function as a pre-compiled interpreter for the language.

The final model may be to develop a compiler for the XmURL that creates byte code on the server. The byte code may then be deployed to the execution device where a virtual engine may execute the byte code. This final approach may be similar to the Java development model.

Engine as a Price Plan Interpreter

The first deployment model transmits the XmURL set of documents, as is, down to the device where they are stored in their current format. Once on the device, the engine's Price Plan Manager may select the appropriate plan to be used during its boot sequence. Typically, a consumer may subscribe to a particular price plan for the device onto which the price plan is loaded. Thus, it is only necessary to provide rating instructions for that device and that subscription rather than an ubiquitous rating program. The price plans may be customized to the consumer. The XmURL document may be then parsed by the engine to create a binary execution tree from the original XmURL document. These documents may be updated by sending new XmURL documents down to the device to replace the existing documents. The engine may be also capable of having multiple documents available, each with different effective dates.

During the parse phase, the engine must evaluate the XML structure and allocate any necessary memory as it encounters various elements within the XmURL document. Given that the devices may be constrained, the XmURL document may be validated against the schema during the publishing process of the document. The device may not validate the document prior to attempting the parse step. The engine may preferably guard against errors in the document, as well as errors resulting from memory allocations throughout the parse phase.

When a usage event may be sent into the engine, the binary execution tree may be ‘executed’ to perform the rating. Any side effect of performing the rating function exists within the Context of the event. The Device Based Rating Engine may persist any side effects in the Context, such as changes to the Accumulation fields.

Interpreter Engine Design

The interpreter design may have two phases. The first phase involves parsing and constructing the Price Plan. Once completed, the Price Plan can be provided to the Interpreter Engine for execution in the second phase.

Build Phase

Referring to FIG. 1, an example of entities involved in the creation of the Price Plan (150) and the Interpreter Engine (140) is shown. The Price Plan (150) may be a binary tree object that represents the XmURL document (175) after parsing. The Price Plan binary tree may be executed by the Interpreter Engine (140) to price an event.

The main entity may be the Builder (125), which has the responsibility of using various XmURL documents (175) and the XML Parser (110) to construct the Price Plan binary tree. The Builder (125) is part of the Interpreter (140) that passes the ZXmURL Document (175) and builds the execution tree which is used by the DBR engine to rate an event. The Builder (125) itself may not be responsible for determining which XmURL Documents (175) should be loaded. That knowledge and responsibility falls on the system that encapsulates the Interpreter Engine (140). This hosting system, such as the DBR, may select the appropriate XmURL documents (175) from its environment and provide those documents to the Builder(125). The Builder (125) will parse each XmURL document (175) provided. Any import statements that refer to other XmURL documents (175) should be located within the list of the XmURL documents (175) passed to the Builder (125).

The XML Parser (110) used by the Builder (125) may be a non-validating lightweight SAX parser. The XmURL documents (175) must be valid XML documents (175) and must further conform to the published XmURL Schema. Due to the targeted constrained execution environments, the Parser (110) does not verify the XmURL document (175) against the Schema prior to parsing the XmURL documents (175). In the event a document does not conform to the Schema, either the XML Parser (110) or the Builder (125) may error out the entire XmURL document (175) during the Parse and Construction phase.

The Builder (125) may register its callback functions with the SAX parser for the various XmURL elements. As the Parser (110) encounters these elements, the Builder (125) may be called to consume the elements and attributes. The Builder (125) constructs the binary tree as a list of Actions. Each Action, depending on its type, can have nested Actions.

The Builder (125) expects to find all of the declared subroutines at the beginning of the XmURL document (175). When a Subroutine statement is encountered, the Builder (125) may verify the existence of a defined subroutine binary tree. When the Builder (125) encounters an Import statement, the builder searches its list of XmURL input documents for the named import document. If the named document is not provided, an error may result.

At the end of the parse and construction phase, the Builder (125) may finally construct an Interpreter Engine (140). The engine (140) may be passed the Price Plan binary tree, which may be used during the rating process. The Builder (125) returns the Interpreter Engine (140) and releases any other allocated resources associated with the Parse and Construct phase.

Binary Tree

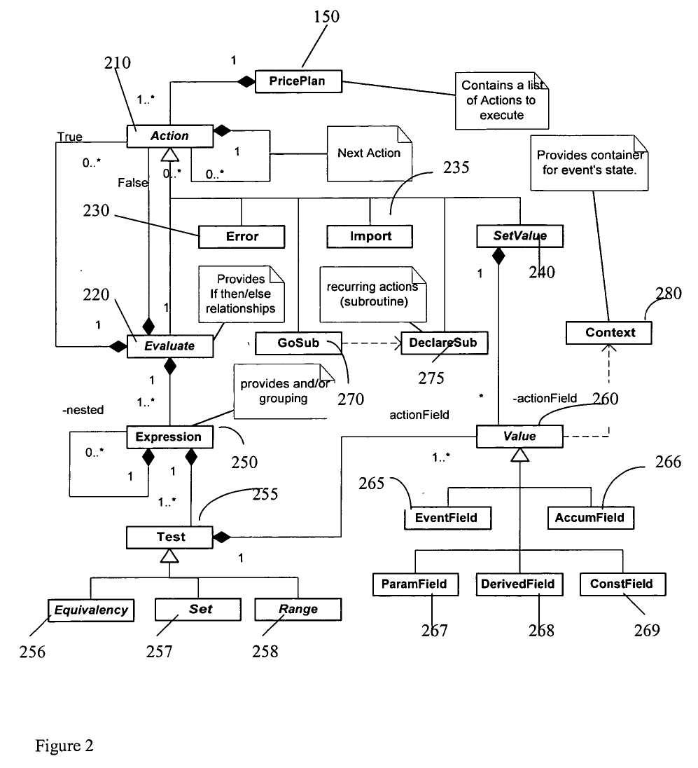

Once the Price Plan (150) may be constructed by parsing the XmURL documents (175), the Interpreter Engine (140) has a binary tree to execute. Referring to FIG. 2, the following diagram depicts the main entities involved in the binary tree.

Price Plan

The Price Plan (150) may be the binary tree used by the Interpreter Engine(140). It may consist of a list of Actions (210) to execute one after another. As long as the return code from an Action (210) does not reflect an error condition, the Action (210) execution may continue.

Action

An Action (210) may be the super type for the other actions, such as Evaluations (220), Errors (230), and SetValue (240). It acts as an interface that exposes a standard set of methods to perform the action, validate the action and destroy the action.

Evaluate

Evaluate (220) may be an Action (210) that controls all “If/Then/Else” logic. Its action may be to evaluate its expression and determine the next path of execution.

Evaluate (220) also holds a set of Actions for True and a set of Actions for False results. Depending on the result of executing the Expression (250), Evaluate (220) may then execute the list of Actions (210) in the appropriate set.

Set Value

Set Value (257) may be an Action (210) that alters a target value utilizing an operation indicator and a source value. The operator may be equals, minus, plus, multiply or divide. Depending on the target value type (i.e., String, Integer, Time), certain operators are invalid. Depending on the target field type (i.e., Derived Field (268), Accumulation Field (266)), the target must exist. In the case of a Derived Field (268), if the value does not exist it will be created. In all cases, the source field must already exist.

Declare Sub

Declare Sub (275) may be an Action (210) that names a set of enclosed Actions (210), which can be executed from other points within the binary tree via the Go Sub Action (270). The Actions (210) within the Declare Sub (275) declaration may include Go Sub Actions (270) referring to other declared subroutines.

Go Sub

Go Sub (270) may be an Action (210) that causes the execution to jump to the list of Actions (210) contained in the declared subroutine. The subroutines must be declared via the Declare Sub Action (275). Once the subroutine has completed, the execution returns to the Go Sub (270) point and resumes.

Error

Error (230) may be an Action (210) that halts execution of the binary tree. The Action (210) carries an error number and message that are returned with the Event. A “catch” mechanism may or may not be supported. Therefore, an Error (230) may be effectively “thrown” all the way out of the Interpreter Engine (140). Once an Error (230) may be thrown, no other Actions (210) are evaluated and the Interpreter Engine (140) completely unwinds its stack to return the Error (230).

Import

Import (235) may be an Action (210) similar to the Declare Sub Action (275). These entities inform the Interpreter (140) to execute the named list of Actions (210) that existed externally to the current binary tree. Once the execution completes, the next Action (210) may be executed in the current binary tree.

Event Context

The Event Context (280) may be created by the hosting system for each event that is to be rated. The Event Context (280) maintains the state associated with the rating of the single event. The Event Context (280) provides access to the various types of fields supported in the engine. All side effects of the rating process are retained in the Event Context (280). The hosting system may extract the side effects from the Event Context (280) and use the values for billing the account. Upon a successful rating conclusion, the Event Context (280) may contain the price and bucket the account should be debited. The Event Context (280) may also contain the Error(230) that was thrown from the Error Action (230).

Value

The Value entity (260) may be the super type for the five field types utilized by other Actions (210). It exposes an interface to get and set values.

Event Field

Event Field (265) may be a Value entity (260) that manipulates the data in the Event contained within the Event Context (280).

Accumulation Field

Accumulation Field (266) may be a Value entity (260) that manipulates the data in the Accumulation fields in the Event Context (280). The Event Context (280) uses an AccumProxy entity to provide access to the values as they appear within the context of this event. Any modifications to the values are not persisted, but are reflected within the context of this event. These side effects are not persisted until the AccumProxy may be instructed to commit its side effects.

Derived Field

A Derived Field (268) may be a Value (260) that exists only within the Event Context (280). If the field doesn't exist when set, an instance may be created within the Event Context (280). Once the Event Context (280) may be destroyed, so are the Derived Field (268) values.

Constant Field

A Constant Field (269) may be a Value (260) whose contents are set within the XmURL document. These fields may be read-only.

Parameter Field

A Parameter Field (267) may be a Value (260) that maybe obtained from the Interpreter Engine's (140) execution environment. The declaration of the Parameter Field requires a default value to be provided and used in the event the value cannot be obtained from the Engine's environment.

Expression

An Expression (250) may be used to evaluate a list of Tests or additional Expressions (250). The result of executing an Expression (250) may be a True or False value. An Expression (250) result maybe inversed by adding a “Not” attribute to the Expression. Each Expression (250) may be a grouping of Tests (255) and/or other Expressions (250) whose results have an AND or OR relationship. Based on the results during the execution of the Expression (250), the entire Expression (250) maybe short circuited based on the AND/OR relationship of the Expression (250).

Test

A Test (255) may be a super type of a simple check. Tests (255) perform evaluations such as a string comparison, and return a result of True or False.

Tests (255) are grouped into Expression (250) statements and executed within Evaluation Actions (210).

Equivalency

An Equivalency (256) may be a Test (255) that compares two fields. The comparison requires an operator that expresses the type of comparison. The supported operators are: equal, not equal, less than, greater than, less than or equal, greater than or equal.

Range

A Range (258) may be a Test (255) that compares a field with two other fields representing the high and low boundaries. The result of the Range test (258) can be inversed by adding an “out” attribute, which checks for out of range. The high and low boundaries are inclusive in the range test evaluation.

Set

A Set (257) may be a Test (255) that compares a field with a list of other fields representing a valid set of values. The result of the Set test (255) can be inversed by adding an “out” attribute, which checks for exclusion in the set.

Execution Phase

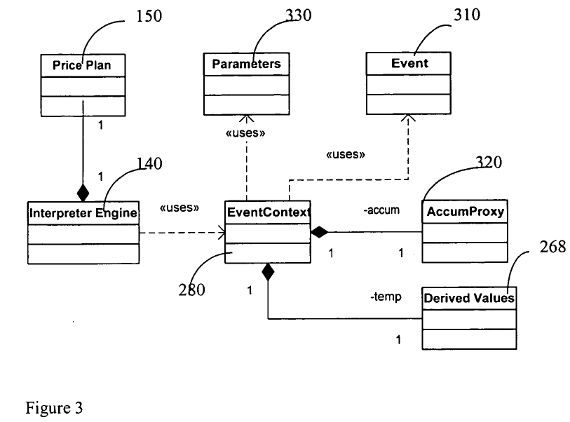

Referring to FIG. 3, once the Price Plan (150) binary tree has been constructed by the Builder (125), the Interpreter Engine (140) may be ready to rate Events. Events (310) may be placed within an Event Context before being passed to the Interpreter Engine (140). All side effects of the rating process are retained within the Event Context (280).

Once the rating step has been completed, the Event Context (280) may be examined to determine if there were any errors thrown. If there were no errors, the XmURL document should set a Derived Value (268) that represents the Price and Bucket to be drawn against. These values can be extracted from the Event Context (280) and used to charge for the event.

During the rating process, the XmURL instructions may require that accumulation buckets be incremented or decremented. For example, the XmURL instructions might determine the content type to be of a certain brand name music, and then increment a “listen” accumulation bucket. The XmURL instruction may further then reference the “listen” count to determine if a volume discount should be applied to the final price of the event. The modification of the “listen” bucket should only be persisted if the event may be actually billed. That action may be out of the scope of the Interpreter Engine (140). Therefore, only the Event Context (280) may be altered to reflect the new value of the “listen” bucket. If the event may be billed by the hosting system, the Event Context (280) must be persisted by committing the Accumulation Proxy.

Optimized Price Plan Interpreter

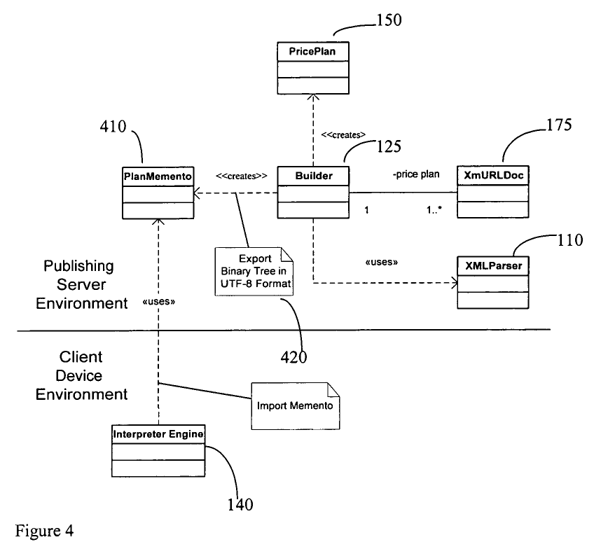

Referring to FIG. 4, the next deployment model builds off of the interpreter model described in the prior section. Much of the engine's design remains the same, however the responsibilities are split between two versions of the engine. One version of the engine exists within the publishing process, and another version exists on the device for execution. For each engine, there may be a small set of core functionality and a set of specialized functionality.

The publishing engine may be responsible for validating the integrity of the document, parsing the document into the necessary binary tree, determining the total amount of memory required by that tree, and finally creating a memento of that tree (410) reflecting the internal state of that tree. The publishing engine doesn't contain the execution portion of the original engine, as it only parses the XmURL document and externalizes the binary tree. The publishing engine executes on either the server, or a workstation as part of the publishing phase.

The execution engine doesn't have to perform all of the parsing, and associated validation of the document. Instead, the execution engine receives the memento of the publishing engine that represents the binary tree in an UTF-8 portable format (420). As part of the memento, the publishing engine informs the execution engine as to the total amount of memory necessary for the entire tree. The execution engine now knows upfront how many structures of each type and char data that must be allocated. The execution engine allocates the memory in a few chunks up front. A large portion of the parsing logic may be dedicated to error recovery from memory allocation errors in the middle of the parse process.

The execution engine no longer requires the same logic, as it just allocated all of its necessary memory. The execution engine can now consume the rest of the memento, and may be then ready to execute the binary tree.

This model provides the following benefits over the standard Interpreter Engine:

Validation of the XmURL documents on the server before they are distributed to the device. Once on the device, incorrect XmURL documents must be corrected and downloaded again.

The exported Memento (410) may be a much smaller representation of the price plan as opposed to the verbose XML syntax. This will result in faster downloads of price plan mementos and a will require less space on the device to store the mementos.

The Interpreter Engine (140) will have a 40% smaller footprint on the device. The Interpreter doesn't require the Builder, XML Parser and a large portion of error checking logic. The engine must guard against invalid documents as well as memory allocation errors. In this optimized scenario, the engine knows upfront the exact amount of memory required to load the memento. Additionally, it knows the memento may be a valid representation.

The Interpreter Engine (140) may have a faster boot sequence as entire XML documents (175) are not parsed.

Engine as a Rating Virtual Machine

As stated above, there are several options for the design and implementation of a device-based rating engine that uses a rating specific language to define the rating price plans and rules. In one instance a source level interpreter could be constructed that interprets a rating specific language such as XmURL.

An alternative design would be to construct a Virtual Machine and corresponding assembler code and execute this assembly code as the embodiment of the price plan. This would be a multi-stage process where the Rating Specific Language such as XmURL was passed through a compiler that would then emit a Rating Specific Assembly Language. This rating assembly language would then be passed into an assembler where it would be transformed into a set of machine level instructions for a Rating Specific Virtual Machine.

A Virtual machine is a software application or construct that acts as a simulated hardware CPU or microprocessor. This virtual machine has a specific instruction set just like a real CPU and executes the instructions that are given to it (as compiled programs) just as a physical CPU does.

The difference is that the execution process occurs in the software that makes up the virtual machine instead of the instructions being handed to the microprocessor; so it is virtual instead of physical. A virtual machine functions as an interface between a high level language that is run through a compiler and the microprocessor (or “hardware platform”) that actually performs the program's instructions.

Normally programs are compiled to a native form for the particular CPU they will run on. The instructions that make up such a program are instructions for the actual CPU they run on (for example an Intel x86 CPU). When using a virtual machine, programs are compiled for the abstract CPU that the virtual machine embodies. Once a virtual machine has been provided for a hardware platform, any program (which, after compilation, is called bytecode) can run on that platform.

The reason is that the bytecode represents instructions for the virtual machine instead of the actual cpu of the hardware. The virtual machine translates its abstract instruction set into the instruction set of the host CPU. It acts as an abstraction layer between the program and the underlying hardware microprocessor. In doing so it isolates the bytecode, so that it can run unchanged on any platform for which the virtual machine has been ported. Virtual machines are designed to allow application programs to be built that could be run on any platform without having to be rewritten or recompiled by the programmer for each separate hardware platform.

A virtual machine defines an abstract rather than a real “machine” (or processor) and specifies an instruction set, a set of registers, a stack, and a code area. Instructions are fetched from the code area and as they are executed they manipulate the virtual machines stack and registers. The real implementation of this abstract or logically defined processor can be in other code that is recognized by the real processor or be built into the microchip processor itself. Typically the virtual machine is itself a program that is compiled for the native microprocessor.

The output of “compiling” a high level source program is called bytecode. A virtual machine typically interprets the bytecode one instruction at a time (mapping it to a set of real microprocessor instructions) or the bytecode can be compiled further for the real microprocessor using what is called a just-in-time compiler.

The philosophy here is simple. The assembler supports a set of primitive building blocks in terms of its types and operations. They are simple number and string types along with basic stack and register manipulation functions. All of the higher level, more complex data types and operations of XmURL are supported by assembling these primitive building blocks together.

Such a virtual machine approach could supply several benefits:

A smaller memory footprint than an interpreter

Faster execution as there may be potentially less random memory accesses.

Ability to support new higher-level language constructs (in such a language as XmURL) without needing to redistribute the execution engine. The new language features would be supported by the compiler, which would be run on the server. The compiler would translate the new language features into the existing assembly language. This would greatly enhance the flexibility of the system and allow for price plan and XmURL language evolution without requiring new in field binary rating engine updates. The only component that would need to be updated would be the compiler. An example would be a switch statement. Currently the XmURL language does not directly support such a construct. Should one be added in the future, the compiler would need to be updated but neither the assembler nor the VM would need to be changed. The switch statement would be translated by the compiler into more primitive test and jump instructions.

A binary VM assembly file would be more difficult to reverse engineer.

This could provide an additional level of security.

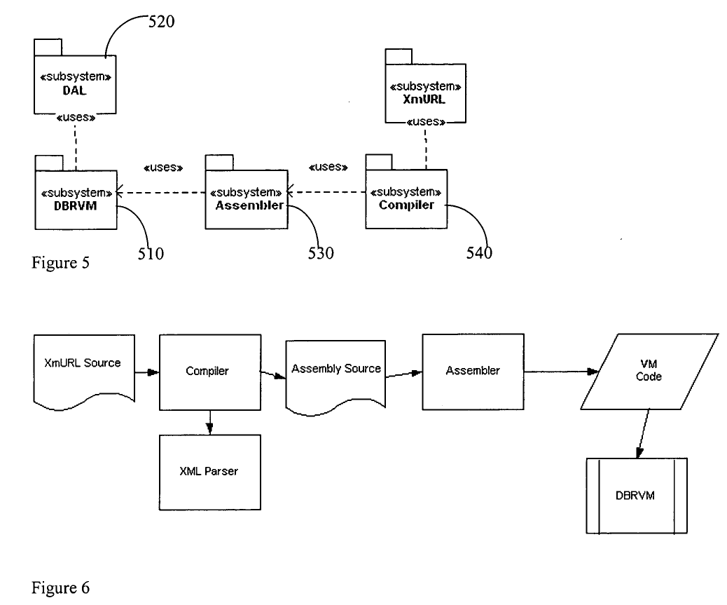

Referring to FIG. 5, the DBRVM system defines the following packages or subsystems:

DBRVM

The heart of the system may be the DBRVM (510), a rating specific virtual machine. The implementation of this virtual machine will depend upon a Device Abstraction Layer Package (DAL) (520). The DBRVM (510) represents the on-device runtime part of the system. The virtual machine defines a core set of opcodes and operands that the assembler will use.

Assembler

The assembler subsystem (530) takes the assembly language output of the compiler and creates a binary load module for the DBRVM (510). It uses the opcodes and operand descriptions supported by the DBRVM (510) and formats them into an appropriate binary image. This image may then be downloaded to the device for execution by the virtual machine.

Compiler

The compiler (540) uses the rating specific assembly language constructs supported by the assembler (530). The compiler's job may be to take the high level rating specific language (XmURL) description of a price plan and translate that into the DBRVM assembly Language. This will involve activities such as if-then logic translation into jumps, variable to register translation, etc. The Compiler (540) may be dependent upon the language constructs supported by the XmURL language.

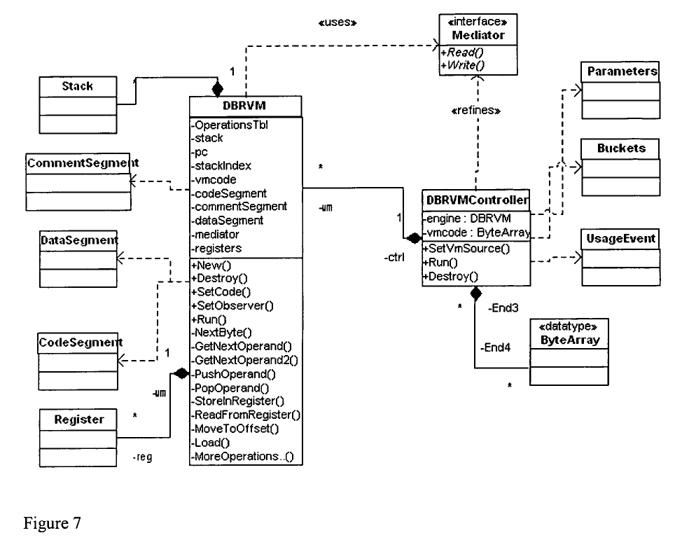

Referring to FIG. 6, the processing model may be to take the XmURL source and send that through a Compiler, which will in turn use a XML parser. The compiler will output assembly source. That source will be input to an assembler. The assembler will then output VM code that the DBRVM can execute.

It should be understood that the compiler and assembler do not have to work just on source files. The use of source above may be simply descriptive. They can and in fact most likely will simply work on in memory strings. The preferred embodiment will be for these subsystems to run within a server process on the gateway and act as in line filters during the provisioning process. This would allow them to act just in time and in concert. It could also be so arranged that the in memory representations that each use could be shared eliminating the need for the sharing of strings. Both processors however could also be separated out and work on source files for testing purposes.

Virtual Machine Design (DBRVM)

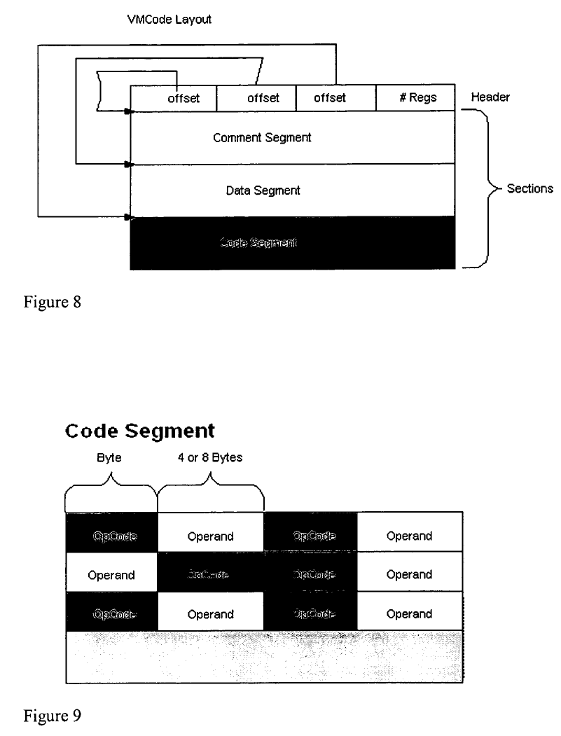

The DBRVM may be an implementation of a rating virtual machine. Referring to FIG. 7, the following diagram illustrates its general composition.

DBRVM

The central entity may be the Virtual Machine itself (DBRVM). It may be created by a DBRVMController that manages its lifecycle and processing. The VM has several subcomponents. First may be a stack that is used during code execution. The VM execution stack model may be explained below. The VM also offers a set of registers that are typically used to hold intermediate execution values such as language variables. There are two ways to implement a Virtual Machine. In one model a stack may be used to hold all of the execution flows. This has the benefit of fast execution time and lower memory constraints. It however can impose additional constraints on the assembler and compiler. Another model may be to use a set of general execution registers that are used not to hold variables but to hold engine execution items. Either model can be used to implement this design.

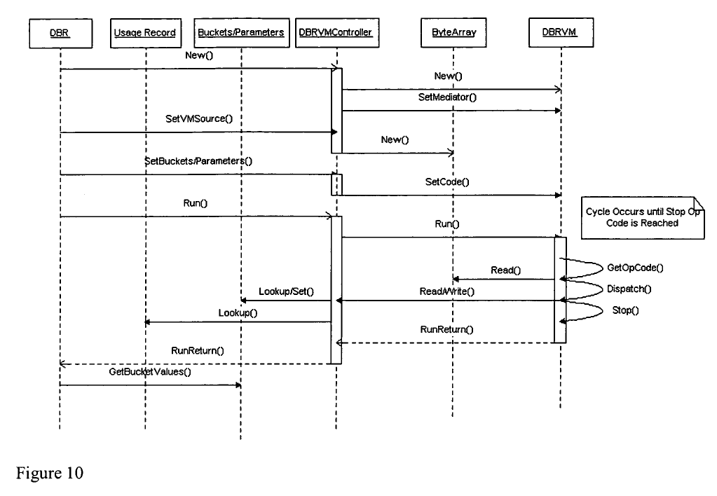

The Virtual machine has an execution module associated with called a VMCode Module. This module encodes the price plan that the engine will execute. Referring to FIG. 8, an example of the VMCode Module layout is displayed.

The module begins with a header record. This record contains offset pointers to the rest of the module as well as an indicator of the number of registers that this code will require. The rest of the module may be divided up into 3 sections or segments.

Comment Segment

The comment segment may be a variable length segment that contains strings. These strings can be used to embed user defined information into the VMCode Module. It can also be used to embed debugging information or symbolic information that could be used by a disassembly tool.

Data Segment

The data segment may be a variable length section that holds a series of null terminated strings. These strings are used to provide symbolic representation of data. The main use may be to allow for storage and retrieval by symbolic name for Rating Buckets and parameters. There are specific rating operations in the assembler that use these symbols to interface into the mediator for data transfer of rating bucket values.

Code Segment

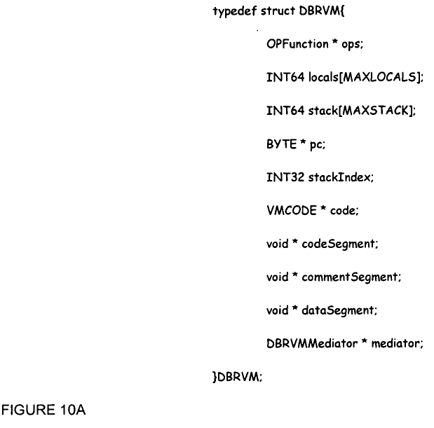

The code segment holds the actual binary encoding of the assembly language that the VM supports. Referring to FIG. 9, it has the following general layout.

The code segment may be made up of a series of Opcodes and Operands. The Opcodes are a Byte in length. An Opcode may be followed by zero or more operands. These operands may be 32 or 64 bit values depending upon the op code. The opcodes encode the basic operations of the virtual machine: load and item onto the stack, move an item from the stack into a register, jump to a code offset, etc. The assembler section that follows details all of the op codes and their operands.

The operands themselves follow the opcode and may be any of the following:

Constant Numeric Value

Constant Date

Offset into the Data Segment for symbols

Offset into the Code Segment (used for jumps)

Register Number

Mediator

As the VM executes the rating assembly code, it will need to interface with the rest of the DBR System specifically to get Bucket Values, Usage Event values, processing parameters and then to store bucket values. The mediator may be an interface that provides services for these actions. The mediator supplies two main functions:

Read—Takes a String Value and Returns a 64 or 32 Bit Value

Write—Takes a String Value and a 64/32 bit value and stores it.

If different namespace scopes were required (same symbol used both for a bucket value and a parameter name) then a type code could be passed. This could be done either by passing two operands to the opcode instructions that needed to interface (.loadx and .storex for example) or the type could be pushed on the stack and the op code use two values off of the stack. Another alternative would be to use a formatted string (such as Type&Value) as the argument.

DBRVMController

The DBRVMController has two main responsibilities. First, it manages the lifecycle of the virtual machine. It creates the VM, and assigns the VMCode module to it. This allows the VM to be decoupled from the specifics of the provisioning and storage of the price plans themselves. The DBRVMController also initiates the price plan calculation by executing the run method on the DBRVM.

The second responsibility for the controller may be to implement the Mediator interface supplying bucket and usage event data and then storage for the VM. The Controller will hold references to these items and use them to look up and store values for the VM.

Execution Model—General LifeCycle

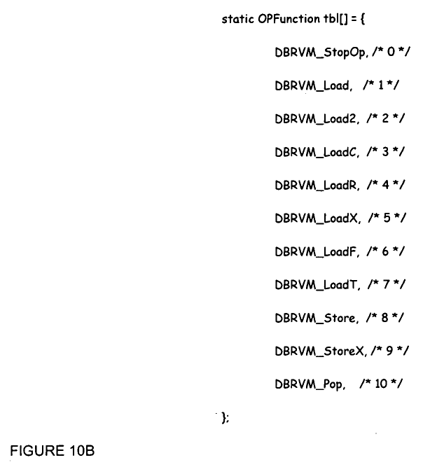

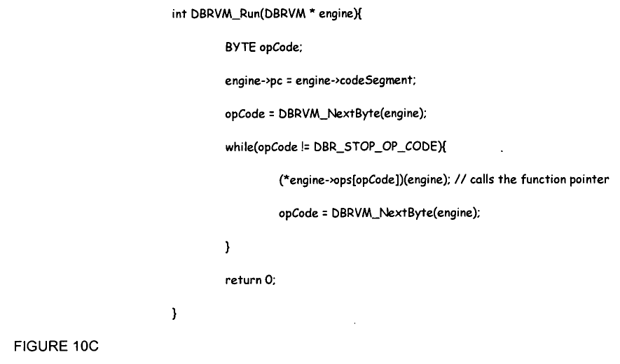

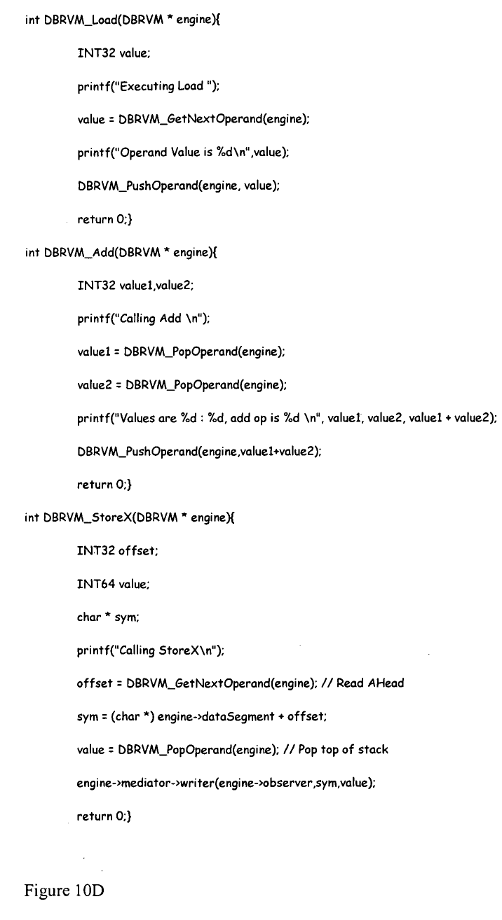

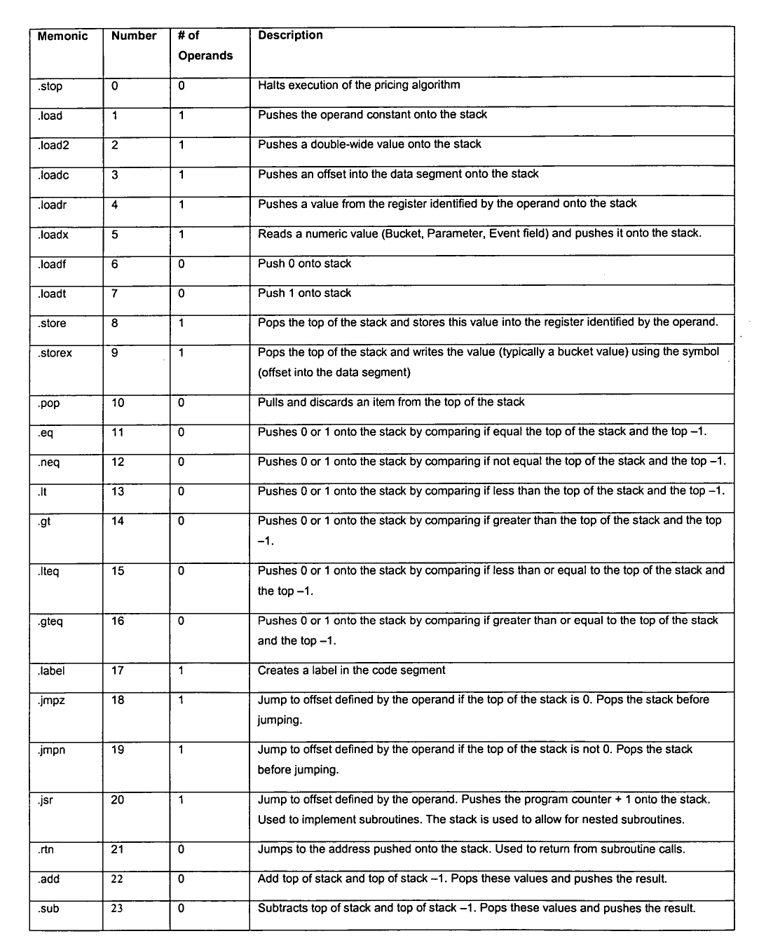

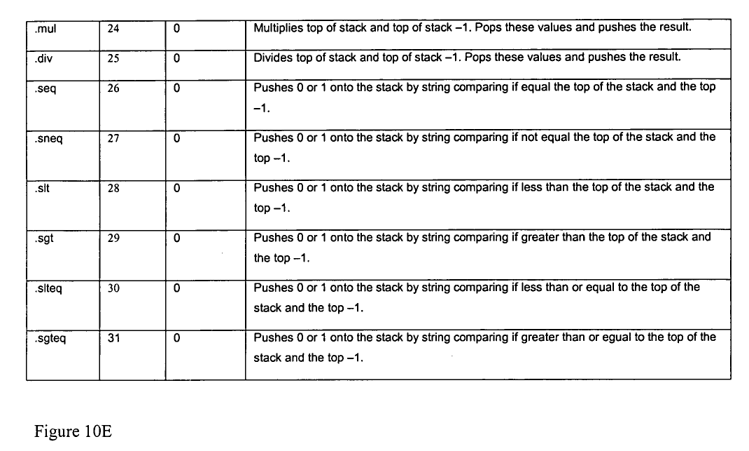

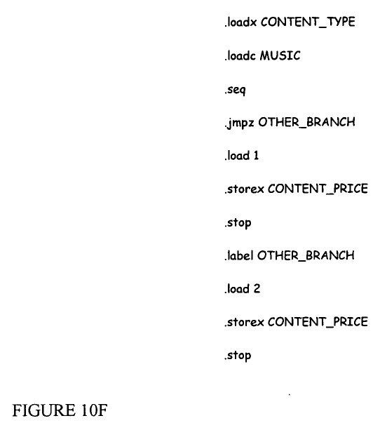

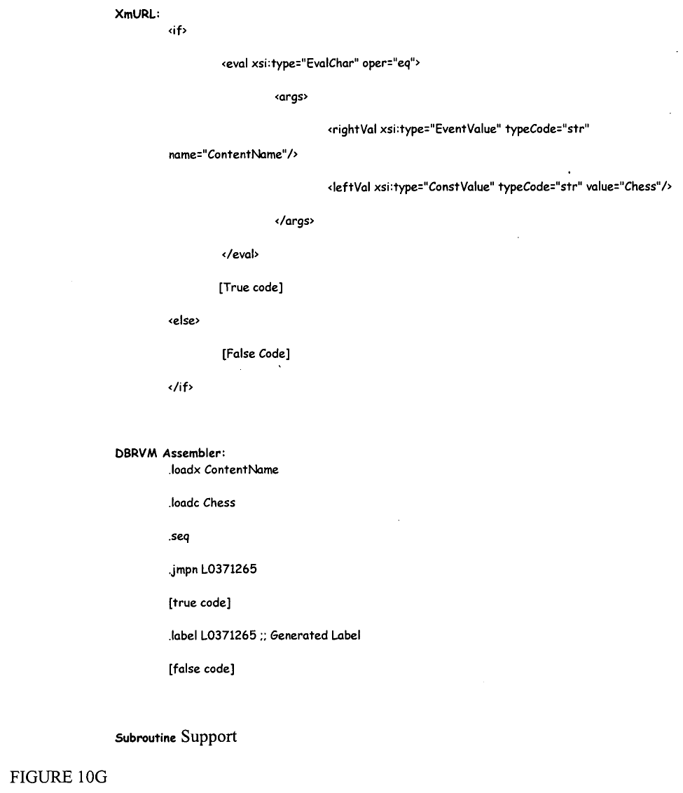

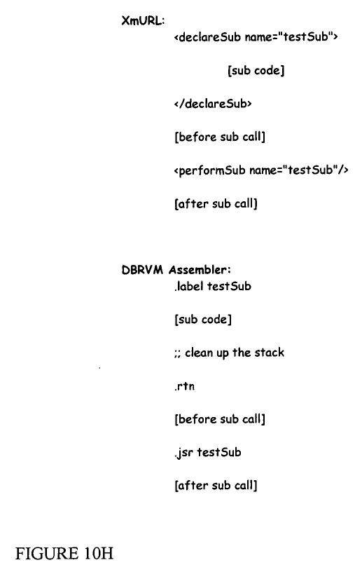

Referring to FIG. 10, the following sequence model illustrates the major flows described here:

As stated above, the DBRVM could use either a stack based execution model or a register based execution model. The following description illustrates a stack-based model. A register-based model would be similar except that intermediate results would be stored in registers instead of on the stack.

In a stack-based implementation, all operations use the stack for execution. In general, most of the op codes themselves operate on the stack either by pushing items on it, pulling items off of it or executing some command on the stack values.

Once the DBRVMController has created the DBRVM and set the VMCode the DBRVM decodes the segments and sets its internal pointers to point to the different segments in the VMCode Module. It then allocates a stack and sets its program counter (pc) to point to the beginning of the code segment. When Run is called it may begin an execution loop. The loop first reads a byte that contains the op code. It then looks up a specific routine to call based on that op code. This mapping may be contained in a jump table that matches op codes to function pointers. The VM then calls the routine pointed to by the function pointer. That specific op code VM routine will then read the operands from the code segment and then perform the code associated with that op code. Each specific read from the code segment adjusts the pc counter. That op code routine will return and the VM will read the next op code. If the code is not a stop then it may again dispatch to the appropriate op code routine. This continues until a stop code may be reached.

To illustrate this execution model and to show a concrete example of the binary code a simple numeric addition example follows. The example adds the numbers 4 and 6 and then stores the result of 10 by calling into the Mediator to store the result using the symbol Result

First the code may be assembled into a stream of binary byte codes and operands:

;; Example of the addition of 4 and 6, storing the result under symbol Result

.comment Addition Example

.load 4

.load 6

.add

.storex Result

.stop

The following may be a hex dump of the resulting assembled image:

00000000: 0d00 0000 1e00 0000 2500 0000 4164 6469
.......%...Addi
00000010: 7469 6f6e 2045 7861 6d70 6c65 2052 6573 tion
Example Res
00000020: 756c 7400 0104 0000 0001 0600 0000 1509
ult...............
00000030: 0000 0000 00 .....

The first 12 Bytes, 0d00 0000 1e00 0000 2500 0000 are the offsets into the other segments. The Comment Segment starts at byte 13 (x0d), the Data Segments starts at offset 1e and the Code Segment starts at offset 25. The Comment Segment contains the string “Addition Example”. The Data Segment has the Null Terminated string Result. The code segment contains the following bytes:

0104 0000 0001 0600 0000 1509 0000 0000 00.

Here is stream segmented into op codes and operands:

(01) (04 0000 00) (01) (0600 0000) (15)(09) (0000 0000) (00)

The VM contains a program counter (PC). At the beginning the PC may be set to point to the beginning of the code segment. When run is called the VM may read the first byte. The first byte may be the load instruction (01). This operand pushes the operand that follows onto the stack. The Next 4 bytes may be the load instruction operand (0104 0000 00) which is the number 4. The load routine will then push 4 onto the stack and return.

The VM then decodes the next op code. Again it may be a load instruction (01). This may be followed by a 4 byte operand (0600 0000). Again the load routine runs and pushes a 6 onto the stack. So the stack has 2 items on it, a 4 followed by a 6. The load routine returns and the VM decodes the next instruction. This next instruction may be an add instruction (15). The add instruction takes no operand.

Instead it may pop two items from the stack, add them together and push the result [10] onto the stack. So after the add op code runs the stack then has one item (the number 10) on it.

The VM then reads the next op code. It may be a storex instruction (x09). The storex instruction will pop the the top value off of the stack [10] and store it under a symbol by calling into the Mediator interface and invoking the write function. The symbol to be used may be found in the operand following the op code. The operand here may be (0000 0000) and represents the offset into the data segment where the null terminated string can be found. In this case it's the string “Result”. The store instruction will therefore call Mediator::Write(“Result”, 10). The mediator will then store this value under the appropriate symbol (generally in a temp area that will later be flushed into a bucket). The last instruction may be the stop instruction (00). The engine will then return to the DBRVMController and will reset the program counter to the beginning of the code segment and reset all of the registers.

In this example the stack provides the execution area for all of the operands. As stated above, This is only one way to implement the VM. An alternative implementation model would be to use a set of execution registers instead of a stack. Either model could be used as an embodiment of this rating assembly design.

Here the DBR Application creates a DBRVMController by calling New. This controller then creates a DBRVM instance and sets itself as its mediator. The DBR then sets the VMSource on the Controller and sets its buckets and parameters. The controller subsequently sets up a byte array. It then sets the code on the DBRVM. Next a Run method may be called by the DBR on the controller suppling a usage record. The controller stores the usage record and uses it along with the buckets and parameters to supply the Mediator interface functions. The Run method may be then called on the DBRVM engine which then gets op codes and dispatches. These will manipulate the stack, registers and call functions on the DBRVMController (acting as the Mediator) to read and write parameters, bucklet values and to read usage data. When a stop op code may be reached the process completes and the Run method returns.

Code Samples

The following code samples illustrate some possible implementations in C. Error handling has been omitted.

Data Structure

Referring to FIG. 10A, an example of a data structure that captures the the elements of a DBRVM is shown.

Dispatch Table (Jump Table)

Referring to FIG. 10B, an example of a dispatch table that uses op codes as indexes into a jump table that contains function pointers is shown.

Here is an example of a run op code dispatching routine in C:

Op Code Instruction Implementation sample

Referring to FIG. 10D, here is an example of a stack based implementation of a load instruction, followed by an add instruction, followed by a storex implementation

Assembler Design

As stated above, the unique DBRVM model is to use rating specific op codes to encode rating algorithms defined by a price plan. In using common patterns understood by one skilled in the art, these op codes are given mnemonic names. These names along with the understood operands comprise an assembly language for the DBRVM. A series of these mnemonics can be captured in source format. The purpose of the assembler is to translate this series of mnemonics with the corresponding operands into the binary codes understood by the virtual machine.

Example Assembly Codes

Referring to FIG. 10E, the following table captures one embodiment of such an assembler for a stack based virtual machine. These are a minimal set of op codes to perform the rating function.

Example Assembly Program

Referring to FIG. 10F, there is a sample assembler program. It reads a value for CONTENT_TYPE and compares it to the constant MUSIC. If they are string equal then sets the CONTENT_PRICE to be 1, otherwise it jumps and sets the content type to be 2.

Assembler Design

The assembler may be basically a text translator that takes the mnemonic inputs and outputs them into the correct binary format for the VM. It does this by tokenizing an input stream, matching an output pattern and then writing the binary format according to the VM standard.

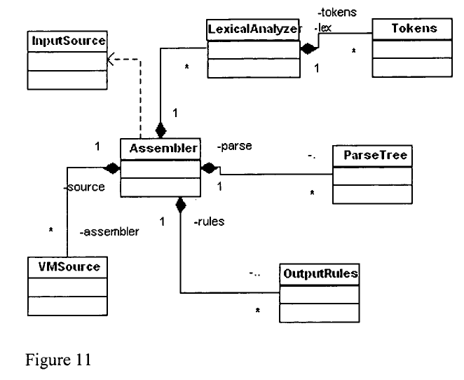

Referring to FIG. 11, the Assembler may be the controller of the overall processes. It uses a lexical analyzer to breakup the input source into tokens that it can then constitute into a parse tree. The parse tree may be then walked and when the pattern may be matched with a set of output rules for a specific op code output type, a binary representation may be written.

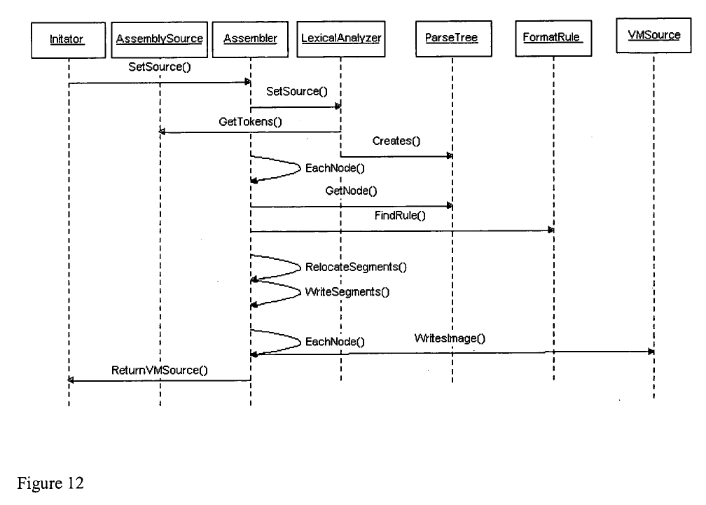

Referring to FIG. 12, the diagram illustrates the sequence of actions:

Major Sequence

Some initiator creates the Assembler and then the Assembly Source may be set. The Assembler then creates a lexical analyzer that creates a parse tree. Once the tree may be created the Assembler walks it. As patterns are matched certain formatting rules are fired. The nodes are processed for offset information. Once the nodes have been updated the Assembler then relocates all of the nodes. Once that may be complete the tree may be walked again to write each node into the appropriate segment. When all of the segments have been written the final image may be assembled and then returned to the initiator.

There are 3 main categories of opcodes and processing. Each op code will fall into one of these categories.

Simple No Relocation

With Simple No Relocation, post processing may be required. The binary representation of the op code can be written followed directly by writing the operand just as it was given. The operand may be output directly into the VM source. The .load instruction may be an example of such an op code. Here the binary representation of .load (0x01) may be written for example as a single byte. This may be followed directly by the binary output of the operand.

Data Relocation

Data relocation occurs when a symbolic name may be given as an operand. For data relocation, this symbol must be stored into the data segment and the offset into that segment substituted as the operand. This can be done in one single pass. Once a symbol has been saved into the data segment, subsequent instances of that same symbol will all be relocated to the same offset. This saves memory both in transmission and in the devices. The opcode .storex may be an example opcode that needs data relocation.

Code Relocation

Code relocation occurs with jump and label instructions. When a label may be identified, it must be replaced with the offset into the code segment. This may require a two level pass through the parse tree. The first level finds all of the labels and calculates their offset. The second pass substitutes all the occurrences of this label with this offset. Once this second pass has been completed, the output functions that assemble the binary images can be invoked.

Compiler Design

The compiler will work similar to the assembler described above. Since XmURL may be in XML syntax, an XML Parser will supplement the lexical analyzer. The same process however will be used to identify patterns and when matched fire special output rules. These will need to match the semantic features of the XmURL language. Specifically the compiler would need to support the type system that XmURL uses (strings, dates, ranges, etc) as well as the structural aspects to the language (conditional processing, subroutines, etc). The compiler will need to transform these types and constructs into the simpler number based constructs that the DBRVM assembler supports. This may be in keeping with the philosophy that the assembler may be a more primitive set of building blocks out of which the more complex language and type features are supported.

There are several specific areas of transformation that the compiler must perform.

Variable Identification and Register allocation

The DBRVM maintains a set of registers to hold variable values during execution. XmURL uses symbol names for variables. These symbols will need to be replaced in the output assembler with register values. The compiler will need to keep a running track of the allocated variables and perform inline substitution of the variables with register id or in the case of assignment allocate new register indices.

Conditional expansion

XmURL supports if then else type logic. The DBRVM assembler only supports simple test and branch type processing. One of the major jobs of the compiler may be to translate the conditional structure of XmURL into jmpz, jmpn constructs. This will require the creation of compiler generated labels.

For Example the following XmURL code fragment that provides a conditional expression would be translated by the compiler into the following assembler:

XmURL directly supports subroutines. Subroutines support in DBRVM requires translating the name of the subroutine into a label and setting up an appropriate return value.

The implementation of the jsr instruction will need to setup the return address to point to the offset directly after the jsr operand. It will push this value onto the stack. The stack may be used in order to support nested subroutine calls.

Dates

XmURL as a rating specific language supports several date types and operations. Currently the DBRVM does not directly support these types or operations. The compiler will need to translate date comparisons into the appropriate numeric comparisons. There may need to be specific transformations done in the Mediator for dates between the VM and the rest of the DBR. Should date types need to be supported, a set of comparison op codes could be made that were date specific.

Ranges

XmURL also supports a range data construct and set of operations. These will need to be translated into equivalency tests and jump instructions.

### Conclusion

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method by which a device may be configured to process a price plan comprising the steps of
defining a price plan in a programming language designed for configuring rating algorithms;
loading said price plan onto a device wherein said device is configured with
i. a device based rating engine; and
ii. a source level interpreter for said programming language.

2. A method as claimed in claim 1 wherein said programming language is a deriviative of XML.

3. A method as claimed in claim 1 wherein said source level interpreter is configured to perform the following steps:
select an applicable price plan;
parse said price plan to create an execution tree;
receive an event; and
execute said price plan as represented by said execution tree.

4. A method as claimed in claim 1 wherein said price plan is constructed to minimize processor resources by providing the code for particular usage patterns in a preferred order.

5. A method as claimed in claim 4 wherein said preferred order is based upon a survey of consumers.

6. A method as claimed in claim 4 wherein said preferred order is customized based upon a set of stated preferences from an individual consumer.

7. A method by which a device may be configured to execute a price plan comprising the steps of
defining a price plan in a proramming language designed for configuring rating algorithms;
parsing said price plan on a system remote from said device to produce an execution tree; and
loading said execution tree on said device wherein said device is further configured with a device based rating engine.

8. A method as claimed in claim 7 wherein said device based rating engine may be further configured to
receive an event;
select an execution tree applicable to said event; and
execute said price plan as represented by said execution tree.

9. A method as claimed in claim 7 by which a device may be configured to execute a price plan comprising the steps of
defining a price plan in a proramming language designed for configuring rating algorithms;
loading said price plan on a remote device wherein said device is further configured with a price plan parser;
parsing said price plan on said device to produce an execution tree; and
loading said execution tree on said device wherein said device is further configured with a device based rating engine.

10. A method as claimed in claim 9 wherein said device based rating engine may be further configured to
receive an event;
select an execution tree applicable to said event; and
execute said price plan as represented by said execution tree.

11. A method as claimed in claim 7 wherein said price plan is constructed to minimize processor resources by providing the code for particular usage patterns in a preferred order.

12. A method as claimed in claim 11 wherein said preferred order is based upon a survey of consumers.

13. A method as claimed in claim 11 wherein said preferred order is customized based upon a set of stated preferences from an individual consumer.

14. A method by which a device may be configured to execute a price plan comprising the steps of
defining a price plan in a programming language designed for configuring rating algorithms;
compiling said price plan on a system remote from said device into a bytecode representation of said price plan;
loading said bytecode on said device wherein said device is further configured with:
i. a device based rating engine; and
ii. a virtual engine for executing said byte code.

15. A method as claimed in claim 14 wherein said device based rating engine is further configured to
receive an event;
select said byte code applicable to said event; and
execute said price plan as represented by said byte code.

16. A method as claimed in claim 14 wherein said price plan is constructed to minimize processor resources by providing the code for particular usage patterns in a preferred order.

17. A method as claimed in claim 16 wherein said preferred order is based upon a survey of consumers.

18. A method as claimed in claim 16 wherein said preferred order is customized based upon a set of stated preferences from an individual consumer.

19. A device based rating engine configured with a source level interpreter which has been configured to select a price plan stored on said device based rating engine, wherein said price plan is defined in a rating-specific programming language, and further wherein said source level interpreter is configured to parse said price plan into an execution tree which it may implement when the source levl interpreter receives an appropriate event.

20. A device based rating engine configured with a virtual machine for executing a set of byte code compiled from a price plan defined in a rating-specific programming language wherein said device based rating engine may receive an event, select the set of byte code corresponding to said event, and execute said byte code in said virtual machine to calculate a charge associated with said event.
